(19) United States
(12) Patent Application Publication
(10) Pub. No.: US 2016/0372804 A1
(43) Pub. Date: Dec. 22, 2016

(54) Battery having Thermal Plate with Curved Channel Divider

(71) Applicants: Robert KOCH, Orion, MI (US); Babu POTTI, Northville, MI (US); Jeffrey HOLZ, Rochester Hills, MI (US); Robert Bosch GmbH, Stuttgart (DE)

(72) Inventors: Robert Koch, Orion, MI (US); Babu Potti, Northville, MI (US); Jeffrey Buckholz, Rochester Hills, MI (US)

(73) Assignee: Robert Bosch GmbH, Stuttgart (DE)

(21) Appl. No.: 14/901,983

(22) PCT Filed: Aug. 1, 2014
(86) PCT No.: PCT/US14/49391

§ 371 Date: Dec. 29, 2015

Related U.S. Application Data
(60) Provisional application No. 61/861,951, filed on Aug. 2, 2013.
(60) Provisional application No. 61/863,849, filed on Aug. 8, 2013.

(51) Int. Cl. H01M 10/6557; H01M 10/647; H01M 10/613; H01M 2/10; H01M 10/6555

(52) U.S. Cl. CPC H01M 10/6557; H01M 2/1077; H01M 10/6555; H01M 10/613; H01M 10/647

(57) ABSTRACT

A battery assembly in one embodiment includes a battery case defining a first plurality of battery compartments and a second plurality of battery compartments, and a thermal plate defined between the first plurality of battery compartments and the second plurality of battery compartments, the thermal plate including a channel divider dividing the thermal plate into an inlet channel portion located between the first plurality of battery compartments and the second plurality of battery compartments, and an outlet channel portion located between the first plurality of battery compartments and the second plurality of battery compartments, wherein the channel divider includes a first divider portion which extends substantially parallel to outer sides of the inlet channel and the outlet channel, and a second divider portion which curves toward the outer side of the inlet channel portion thereby narrowing the inlet channel portion.

### TECHNICAL FIELD

This disclosure relates to batteries, and more particularly to cooling systems for batteries.

### BACKGROUND

When batteries are charged or discharged, they typically generate heat due to a finite internal resistance that includes ohmic, mass-transfer, and kinetic terms. Exothermic side reactions can also generate heat within the battery. This heat generation can pose a safety risk if it is large and rapid. For instance, commercial Li-ion cells generally go into thermal runaway if the internal cell temperature climbs above the decomposition temperature of the cathode (˜180 to 220° C., depending upon the chemistry and the state of charge). Often, the events that lead to a temperature rise above this critical temperature are triggered at much lower temperatures. For example, exothermic anode film decomposition can occur at ˜120° C., providing enough energy to raise the battery temperature above 180° C.

Even at lower temperatures, undesired damage can occur. For example, at milder temperatures (40 to 100° C. for Li-ion batteries), aging of the battery is usually accelerated. This is due to the fact that most detrimental side reactions are thermally activated (although not all aging mechanisms in batteries are accelerated at high temperature). It is therefore advisable to cool batteries during operation and/or at high ambient temperatures in order to enhance their cycle and/or calendar life.

While battery integrity and health are significant concerns, the incorporation of batteries such as Li-ion batteries, into a vehicle implicates additional concerns. Overheating of vehicular batteries during operation or storage may cause cathode materials to release oxygen gas, which reacts exothermally with the organic electrolyte. Such runaway reactions can also be caused by metallic impurities or Li dendrites that causing short-circuits between the anode and the cathode.

There are numerous cooling concepts for commercial batteries, including active air cooling, liquid cooling, the use of phase-change materials, and the use of materials with high thermal conductivity. The addition of such cooling systems, however, adds weight and manufacturing costs. The efficiency of the cooling system is therefore an important consideration since lower efficiency of a particular system requires the system to be sized larger. Increasing the size of the cooling system is also problematic in applications where size constraints are encountered.

What is needed therefore is a system which provides cooling for a battery. A system which exhibits increased cooling efficiency would be beneficial. A system which could be easily incorporated into existing manufacturing processes would be further beneficial.

### SUMMARY

In accordance with one embodiment, a battery assembly includes a battery case defining a first plurality of battery compartments and a second plurality of battery compartments, and a thermal plate defined between the first plurality of battery compartments and the second plurality of battery compartments, the thermal plate including a channel divider dividing the thermal plate into an inlet channel portion located between the first plurality of battery compartments and the second plurality of battery compartments, and an outlet channel portion located between the first plurality of battery compartments and the second plurality of battery compartments, wherein the channel divider includes a first divider portion which extends substantially parallel to outer sides of the inlet channel and the outlet channel, and a second divider portion which curves toward the outer side of the inlet channel portion thereby narrowing the inlet channel portion.

In another embodiment, a battery assembly includes a first battery container defining a first plurality of battery compartments, a second battery container defining a second plurality of battery compartments, and a thermal plate defined by the first battery container and the second battery container, the thermal plate including a channel divider located at an inner portion of the thermal plate and dividing the thermal plate into an inlet channel portion located between the first plurality of battery compartments and the second plurality of battery compartments, and an outlet channel portion located between the first plurality of battery compartments and the second plurality of battery compartments, wherein the channel divider includes a first divider portion which extends substantially parallel to outer sides of the inlet channel and the outlet channel, and a second divider portion which curves toward the outer side of the inlet channel portion thereby narrowing the inlet channel portion.

In some embodiments the battery case includes a first battery container defining the first plurality of battery compartments, and a second battery container defining the second plurality of battery compartments.

In some of the above described embodiments the first battery container and the second battery container define the thermal plate.

In some of the above described embodiments the first battery container includes a first flange portion, the second battery container includes a second flange portion, and the first and second flange portions define the outer sides of the inlet channel and the outlet channel.

In some of the above described embodiments the first battery container includes a third flange portion, the second battery container includes a fourth flange portion, and the third and fourth flange portions define the channel divider.

In some of the above described embodiments the first divider portion extends about 75-85% of a total length of the inlet channel portion, and the second divider portion extends about 10-20% of a total length of the inlet channel portion.

In some of the above described embodiments the first divider portion extends about 80% of a total length of the inlet channel portion, and the second divider portion extends about 15% of a total length of the inlet channel portion.

In some of the above described embodiments the second divider portion reduces the width of the inlet channel portion by about 25%.

In some of the above described embodiments a height to width ratio for the inlet channel portion is more than 1:10 along the first divider portion.

In some of the above described embodiments the height to width ratio for the inlet channel portion is about 1:16 along the first divider portion.

### BRIEF DESCRIPTION OF DRAWINGS

FIG. 1 depicts a perspective view of a battery assembly according to the present disclosure;

FIG. 2 depicts a perspective view of the battery assembly of FIG. 1 with the battery assembly cover removed;

FIG. 3 depicts partially exploded perspective view of a battery module of the battery assembly of FIG. 2;

FIG. 4 depicts a cross-sectional view of the thermal plate of FIG. 3 looking toward the curved divider portion;

FIG. 5 is a side plan view of one of the battery containers of the thermal plate of FIG. 3 with the other battery container removed showing the thermal plate of FIG. 3;

and

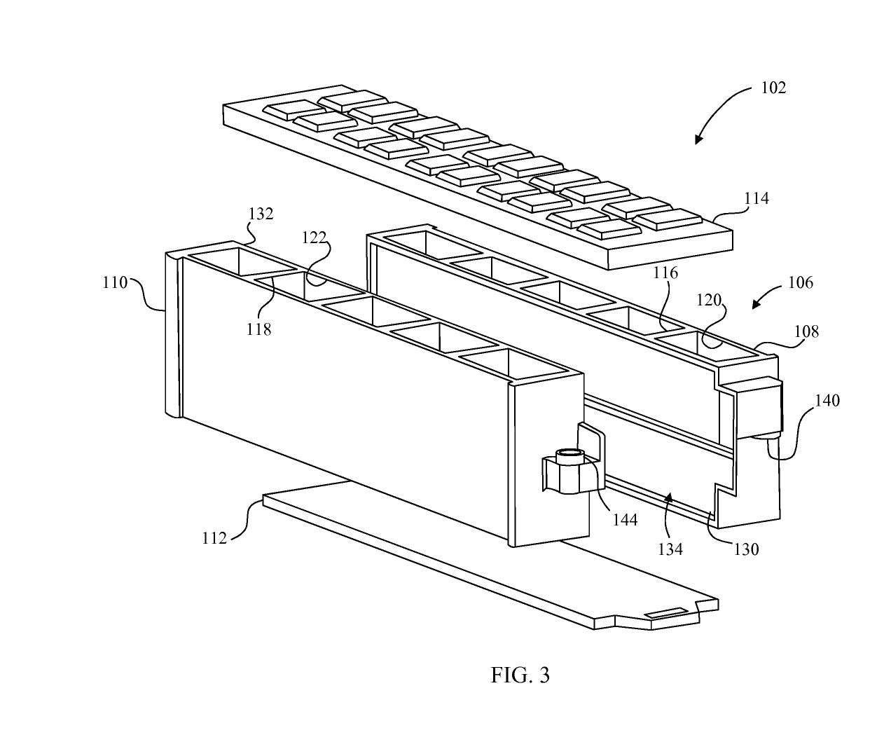

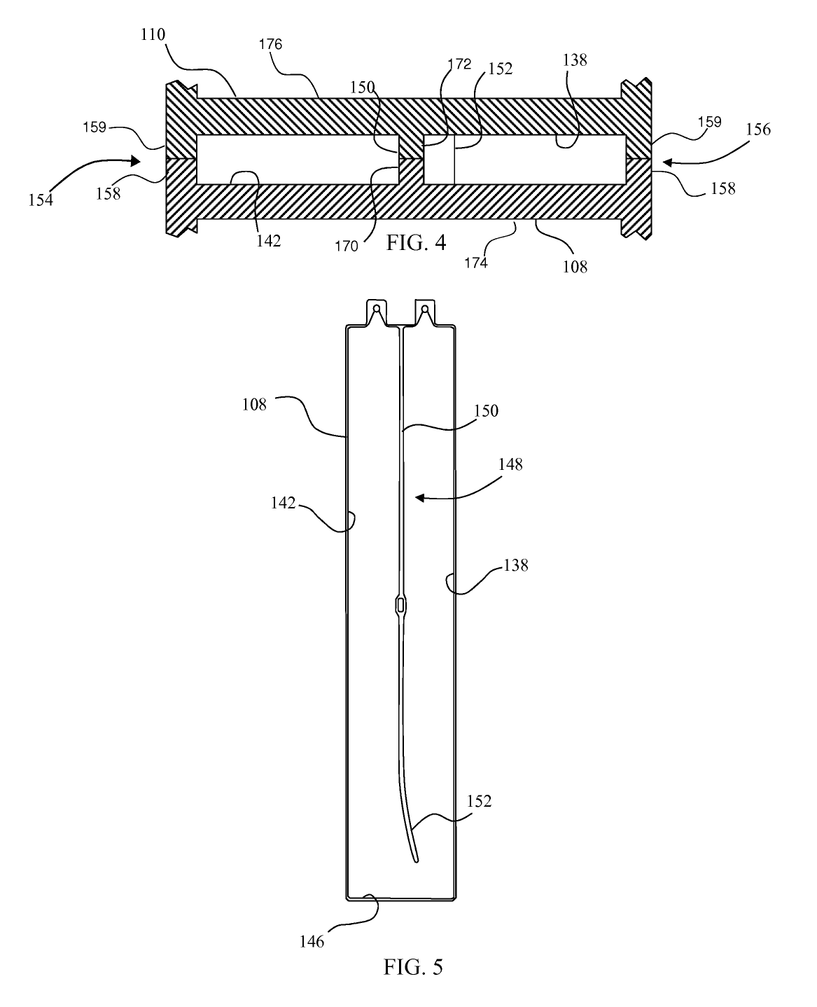

FIG. 4 depicts the velocity of coolant as it flows through the thermal plate of FIG. 3.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

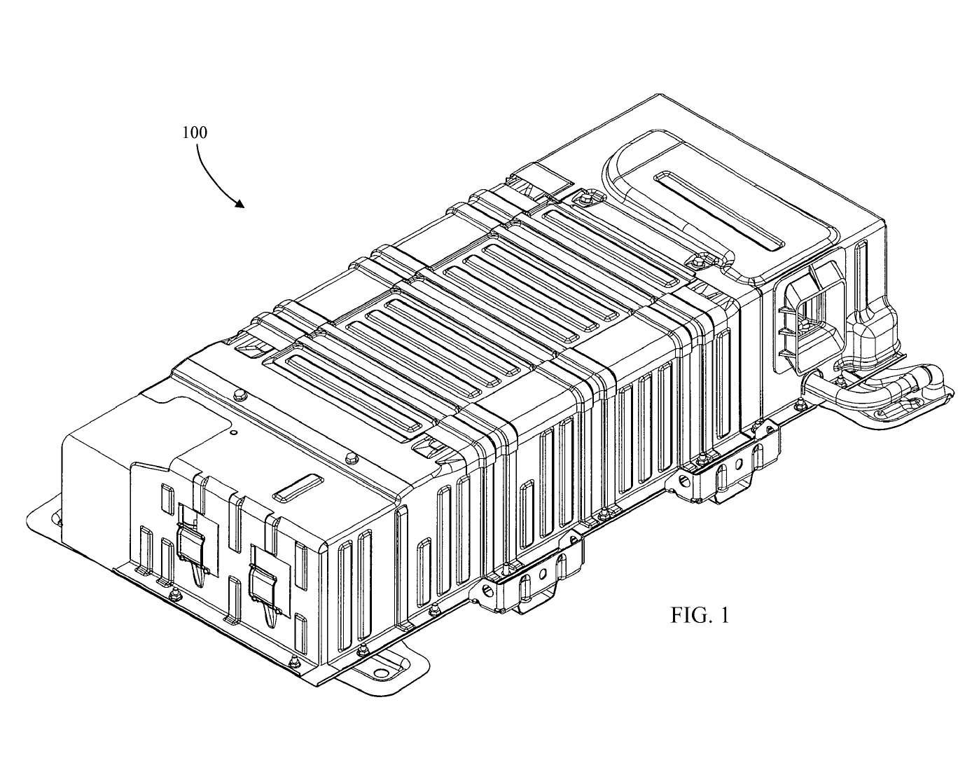

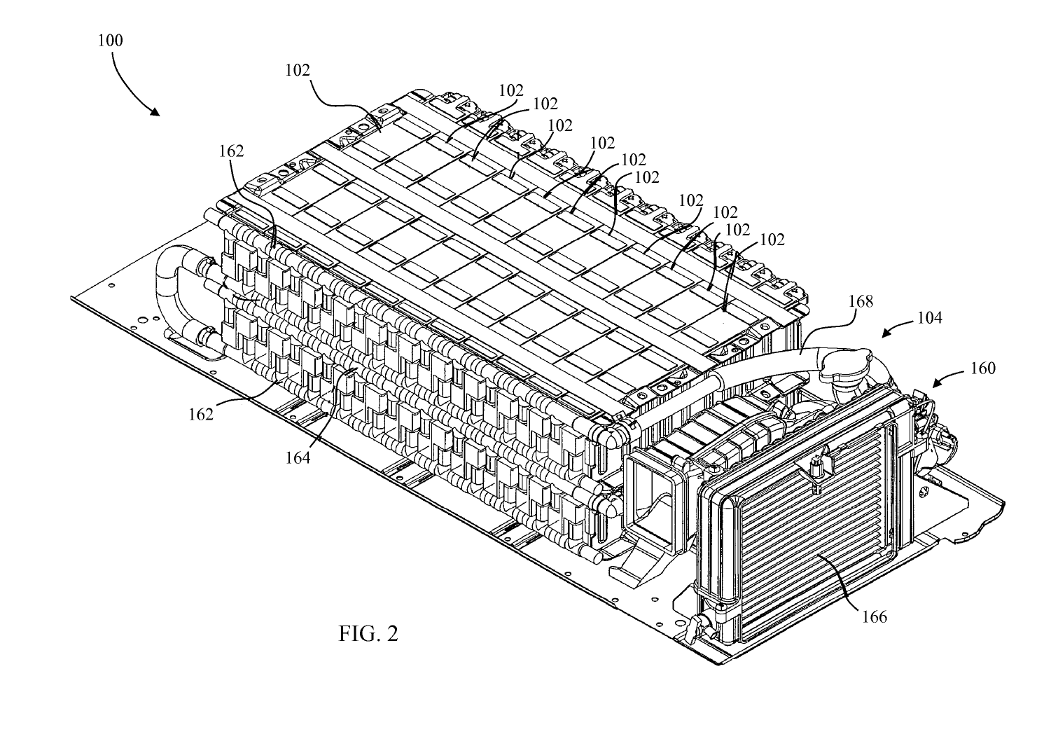

FIGS. 1 and 2 depict a battery assembly 100 including a series of battery modules 102 and a cooling system 104. The battery modules 102 in one embodiment are generally similar to one another. Therefore, a single battery module 102 is described below, with the understanding that the description applies equally to the remainder of battery modules 102. With additional reference to FIG. 3, the battery modules 102 in this embodiment include a case 106 including two battery containers 108/110, a base 112, and a lid 114. The battery containers 108/110 include battery partitions 116 and 118, respectively, forming a series of battery compartments 120/122.

Batteries (not shown) are positioned in the battery compartments 120/122. In different embodiments, the batteries incorporated into the battery assembly 100 include different positive and negative active battery materials. Positive electrode active battery materials in different embodiments include powders of lead oxide, lithium cobalt dioxide, lithium nickel dioxide, lithium manganese oxide compounds, lithium vanadium oxide compounds, lithium iron oxide, and lithium compounds (i.e., complex oxides of the compounds previously mentioned and transition metal oxides, manganese dioxide, zinc oxide, nickel oxide, nickel hydroxide, manganese hydroxide, copper oxide, molybdenum oxide, and/or carbon fluoride). In one embodiment, the positive electrode active battery material includes a nickel hydroxide material.

Negative electrode active battery materials in different embodiments include metallic lithium, as well as like alkali metals and alloys thereof, alkali metal absorbing carbon materials, zinc, cadmium hydroxide, and hydrogen absorbing alloys. In one embodiment, the negative electrode active battery materials include a hydrogen absorbing alloy (also referred to as a hydrogen storage alloy). While the discussion above includes specific examples, it is understood that any hydrogen absorbing alloy may be used. A variety of combinations of positive and negative active battery materials may be used with the battery assembly 100 according to the present disclosure. More specifically, the battery assembly 100 in some embodiments includes a series of batteries in the form of electrochemical cells. In such embodiments, each electrochemical cell may include a nickel-metal hydride cell having positive and negative electrodes. The positive electrodes may include nickel hydroxide as the active material. The negative electrodes may include hydrogen absorbing alloy materials as the active materials.

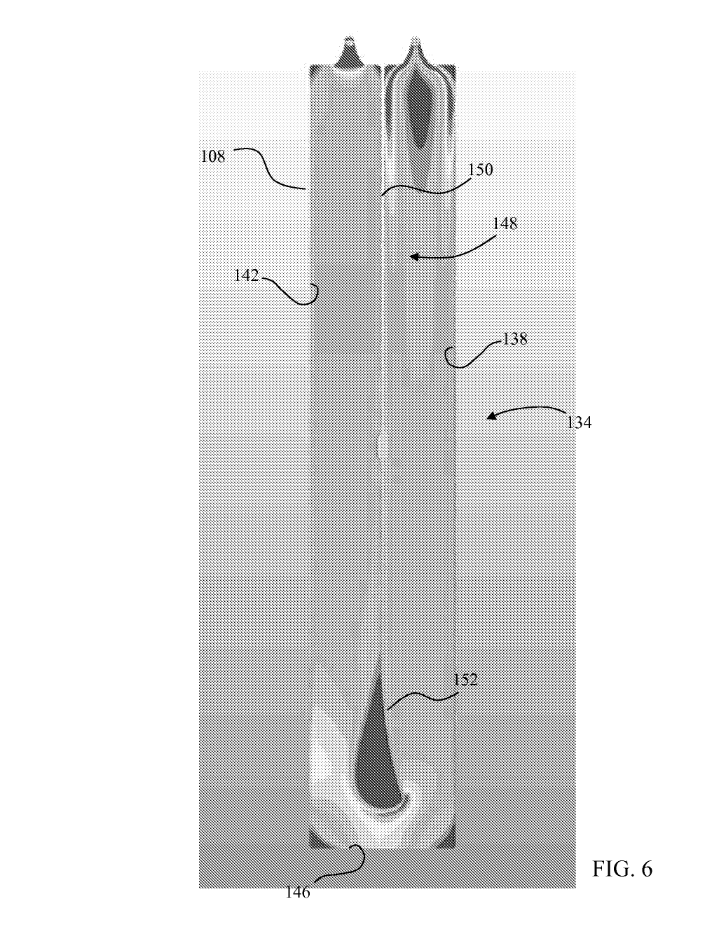

Adjacent faces 130 and 132 of the battery containers 108 and 110 define a thermal plate 134 shown in cross-section in FIG. 4. The thermal plate 134 includes a first channel portion 138 which is in fluid communication with an inlet port 140 (see FIG. 3) and a second channel portion 142 which is in fluid communication with an outlet port 144. As shown in FIG. 5, the first channel portion 138 is in fluid communication with the second channel portion 142 through an end channel portion 146.

The first channel portion 138 is separated from the second channel portion 142 by a channel divider 148. The channel divider includes a first divider portion 150 which is substantially straight. A second divider portion 152 of the channel divider 148 is curved. The first divider portion 150 is parallel to outer sides 154 and 156 of the thermal plate 134, which are defined by opposing flanges 158/159 of the adjacent faces 130/132, respectively. The channel divider 148 is formed by opposing flanges 170/172 which extend out from sidewalls 174 and 176 which are defined by the opposing faces 130/132, respectively.

In one embodiment, the combined width of the first channel portion 138 and the second channel portion 142 is about 160 mm while the length of the first channel portion 138 and the second channel portion 142 is about 900 mm. The height of the first channel portion 138 and the second channel portion 142 is about 2.5 mm. The first divider portion 150 is about 710 mm long while the second divider portion 152 is about 130 mm long. Accordingly, the first divider portion 150 extends preferably about 75-85% of the total length of the channel portion 142, and most preferably about 80% of the length of the channel portion 142, while the second divider portion 152 extends preferably about 10-20% of the total length of the channel portion 142, and most preferably about 15% of the length of the channel portion 142.

Additionally, the curvature of the second divider portion 152 provides about 20 mm of extra width adjacent to the end channel portion 146 for the second channel portion 142 while narrowing the first channel portion 138 by about the same amount. This amounts to about a 25% increase in width for the second channel portion 142 and a 25% decrease in width for the first channel portion 138.

The cooling system 104 in this embodiment is a liquid cooling system and is used to effectuate temperature control of the battery assembly 100. As the batteries of battery assembly 100 charge and discharge, heat is produced. The cooling system 104 provides coolant flow through the battery assembly 100 in order to absorb heat from the battery assembly 100. The cooling system 104 includes a climate control system 160 and a series of inlet and exhaust coolant manifolds 162 and 164.

The climate control system 160 in different embodiments includes a coolant pump (not shown), a radiator 166, a return line (not shown), and a supply line 168. The coolant pump provides for a flow of coolant through cooling system 104. More specifically, the coolant pump forces a flow of coolant through the radiator 166, to the supply line 168, to the inlet coolant manifolds 162, through the first channel portion 138, through the end channel portion 146, through the second channel portion 146, out the exhaust coolant manifolds 164, to the inlet line, and back to the coolant pump, forming a cooling loop. The coolant used in cooling system 104 may include a variety of coolants, such as a 50/50 mixture of ethylene glycol and water.

The above described embodiment provides more efficient cooling of the battery modules 102 because the flow of coolant within the first channel portion 138 and the second channel portion 142 is more symmetrical. FIG. 6, for example, depicts a velocity profile within the thermal plate 134. As is evident from FIG. 6, the curved channel divider portion 152 assists in gradient minimization by creating symmetry in the flow velocity and forcing cooling fluid into the corners of the first channel portion 138 and the second channel portion 142.

Additionally, the thin fluid layer resulting from the low height to width ratio of the first channel portion 138 and the second channel portion 142 (2.5 mm height to 40 mm width in one embodiment) establishes laminar flow thereby minimizing pressure loss and more efficiently reducing the cell temperature due to the shorter conductive distance through the fluid lamina into the higher velocity center stream. The height to width ratio is preferably more than 1:10, and in one embodiment is about 1:16. Moreover, by incorporating a reverse flow between the first channel portion 138 and the second channel portion 142, temperature gradients within the battery modules 102 are minimized.

While the invention has been illustrated and described in detail in the drawings and foregoing description, the same should be considered as illustrative and not restrictive in character. Only the preferred embodiments have been presented and all changes, modifications and further applications that come within the spirit of the invention are desired to be protected.

1. A battery assembly comprising:
a battery case defining a first plurality of battery compartments and a second plurality of battery compartments; and
a thermal plate defined between the first plurality of battery compartments and the second plurality of battery compartments, the thermal plate including a channel divider dividing the thermal plate into an inlet channel portion located between the first plurality of battery compartments and the second plurality of battery compartments, and an outlet channel portion located between the first plurality of battery compartments and the second plurality of battery compartments, wherein the channel divider includes a first divider portion which extends substantially parallel to outer sides of the inlet channel and the outlet channel, and a second divider portion which curves toward the outer side of the inlet channel portion thereby narrowing the inlet channel portion.

2. The battery assembly of claim 1, wherein the battery case comprises:
a first battery container defining the first plurality of battery compartments; and
a second battery container defining the second plurality of battery compartments.

3. The battery assembly of claim 2, wherein the first battery container and the second battery container define the thermal plate.

4. The battery assembly of claim 3, wherein:
the first battery container includes a first flange portion;
the second battery container includes a second flange portion; and
the first and second flange portions define the outer sides of the inlet channel and the outlet channel.

5. The battery assembly of claim 4, wherein:
the first battery container includes a third flange portion;
the second battery container includes a fourth flange portion; and
the third and fourth flange portions define the channel divider.

6. The battery assembly of claim 5, wherein:
the first divider portion extends about 75-85% of a total length of the inlet channel portion; and
the second divider portion extends about 10-20% of a total length of the inlet channel portion.

7. The battery assembly of claim 6, wherein:
the first divider portion extends about 80% of a total length of the inlet channel portion; and
the second divider portion extends about 15% of a total length of the inlet channel portion.

8. The battery system of claim 6, wherein the second divider portion reduces the width of the inlet channel portion by about 25%.

9. The battery system of claim 8, wherein a height to width ratio for the inlet channel portion is more than 1:10 along the first divider portion.

10. The battery system of claim 8, wherein the height to width ratio for the inlet channel portion is about 1:16 along the first divider portion.

11. A battery assembly comprising:
a first battery container defining a first plurality of battery compartments;
a second battery container defining a second plurality of battery compartments; and
a thermal plate defined by the first battery container and the second battery container, the thermal plate including a channel divider located at an inner portion of the thermal plate and dividing the thermal plate into an inlet channel portion located between the first plurality of battery compartments and the second plurality of battery compartments, and an outlet channel portion located between the first plurality of battery compartments and the second plurality of battery compartments, wherein the channel divider includes a first divider portion which extends substantially parallel to outer sides of the inlet channel and the outlet channel, and a second divider portion which curves toward the outer side of the inlet channel portion thereby narrowing the inlet channel portion.

12. The battery assembly of claim 11, wherein the first battery container and the second battery container define the channel divider.

13. The battery assembly of claim 12, wherein:
the first battery container includes a first flange portion;
the second battery container includes a second flange portion; and
the first and second flange portions define the outer sides of the inlet channel and the outlet channel.

14. The battery assembly of claim 13, wherein:
the first battery container includes a third flange portion;
the second battery container includes a fourth flange portion; and
the third and fourth flange portions define the channel divider.

15. The battery assembly of claim 14, wherein:
the first divider portion extends about 75-85% of a total length of the inlet channel portion; and
the second divider portion extends about 10-20% of a total length of the inlet channel portion.

16. The battery assembly of claim 15, wherein:
the first divider portion extends about 80% of a total length of the inlet channel portion; and
the second divider portion extends about 15% of a total length of the inlet channel portion.

17. The battery system of claim 15, wherein the second divider portion reduces the width of the inlet channel portion by about 25%.

18. The battery system of claim 17, wherein a height to width ratio for the inlet channel portion is more than 1:10 along the first divider portion.

19. The battery system of claim 17, wherein the height to width ratio for the inlet channel portion is about 1:16 along the first divider portion.
